(19) United States
(12) Patent Application Publication
(10) Pub. No.: US 2006/0138999 A1
(43) Pub. Date: Jun. 29, 2006

(54) Battery pack locking device of a portable terminal

(75) Inventors: Jae-Shik Kim, Seongnam-si (KR); Jong-Cheon Wee, Yongin-si (KR); Chang-Suk Bae, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/243,077

(22) Filed: Oct. 4, 2005

(30) Foreign Application Priority Data
Dec. 27, 2004 (KR) 10-2004-0112969

(51) Int. Cl. H02J 7/00

(52) U.S. Cl. 320/112

(57) ABSTRACT

Disclosed is a battery pack locking device of a portable terminal including a locking member pivotally engaged with the portable terminal and extending in one direction to press the battery pack mounted to the portable terminal; a resilient member providing a resilient force against the locking plate into the battery pack; and a cover engaged with the locking member so as to be slidably movable.

### PRIORITY

This application claims priority to an application entitled “BATTERY PACK LOCKING DEVICE OF PORTABLE TERMINAL” filed in the Korean Industrial Property Office on Dec. 27, 2004 and assigned Serial No. 2004-112969, the contents of which are hereby incorporated by reference.

### BACKGROUND OF THE INVENTION

1. Field of the Invention

The present invention relates to a portable terminal, and more particularly to a battery pack locking device of a portable terminal.

2. Description of the Related Art

Generally, portable communication terminals are communication devices providing electronic communication functions between users or between a user and a service provider. The user can enjoy various services including voice communication, short sentence messages, multimedia services, and entertainment content while carrying a portable terminal.

Communication terminals are categorized according to their shape, such as a bar-type portable terminal where a transmitter unit, a receiver unit, and data input and output devices are installed in one housing; a flip-type portable terminal where a transmitter unit, a receiver unit, and data input and output devices are installed in one housing like the bar-type portable terminal with a folding data input device, like a key pad; and, a folder-type portable terminal where a pair of housings are foldably connected and a transmitter unit, a receiver unit, and data input and output devices are properly disposed on the pair of housings.

Recently, as consumer need becomes more varied, a sliding-type portable terminal, a popup-type portable terminal, and a swing-type portable terminal has been developed and supplied. Those skilled in the art will easily understand the portable terminals.

For portable terminals, in order to supply electric power, a battery pack is generally mounted to a rear surface of a body housing of the portable terminal. The portable terminal includes a locking device to prevent the battery pack mounted to the body housing from detaching. On a typical portable terminal, a boss receiving a predetermined resilient force and protruding from a battery pack mounting surface is engaged with a recess formed in the battery pack to prevent detachment of the battery pack.

Further, recently, as the functions of a portable terminal becomes more and more varied, camera lenses have become a normally integrated part of newer terminal models. With this, a cover device is generally provided to prevent the exposure of the camera lens when the camera lens is not used.

However, additional devices, such as a camera lens, become an obstacle to miniaturization of the portable terminal. Furthermore, installing a cover on the portable terminal complicates the problem.

### SUMMARY OF THE INVENTION

Accordingly, the present invention has been made to solve the above-mentioned problems occurring in the prior art, and an object of the present invention is to provide a battery pack locking device that allows miniaturization of a portable terminal by integrating a battery pack locking device and a cover for protecting a camera device into one module.

To accomplish the object, there is provided a battery pack locking device of a portable terminal including a locking member pivotally engaged with the portable terminal and extending in one direction to press the battery pack mounted to the portable terminal; a resilient member providing a resilient force applied in a direction in which the locking plate presses the battery pack; and a cover engaged with the locking member so as to be slidably moved.

### BRIEF DESCRIPTION OF THE DRAWINGS

The above and other objects, features and advantages of the present invention will be more apparent from the following detailed description taken in conjunction with the accompanying drawings, in which:

FIG. 1 is an exploded perspective view showing a battery pack locking device of a portable terminal according to a preferred embodiment of the present invention;

FIG. 2 is an assembled perspective view of the battery pack locking device shown in FIG. 1;

FIG. 3 is a cut-away cross-sectional view of the battery pack locking device shown in FIG. 2;

FIG. 4 is a partially cut-away perspective view of the battery pack locking device shown in FIG. 2;

FIG. 5 is a perspective view for showing a battery pack of a portable terminal;

FIG. 6 is a partially cut-away perspective view for showing a state where the battery pack locking device of FIG. 1 is mounted to a portable terminal;

FIG. 7 is a partially cut-away perspective view for showing another state where the battery pack locking device of FIG. 1 is mounted to a portable terminal;

FIG. 8 is a perspective view for showing an operation state of the battery pack locking device of FIG. 1;

FIG. 9 is a partially cut-away perspective view for showing the battery pack locking device of FIG. 8; and

FIGS. 10 and 11 are views for showing a rear surface of a portable terminal including the battery pack locking device of FIG. 1.

### DETAILED DESCRIPTION OF THE PREFERRED EMBODIMENT

Hereinafter, preferred embodiments of the present invention will be described with reference to the accompanying drawings. In the following description, a detailed description of known functions and configurations incorporated herein will be omitted when it may make the subject matter of the present invention unclear.

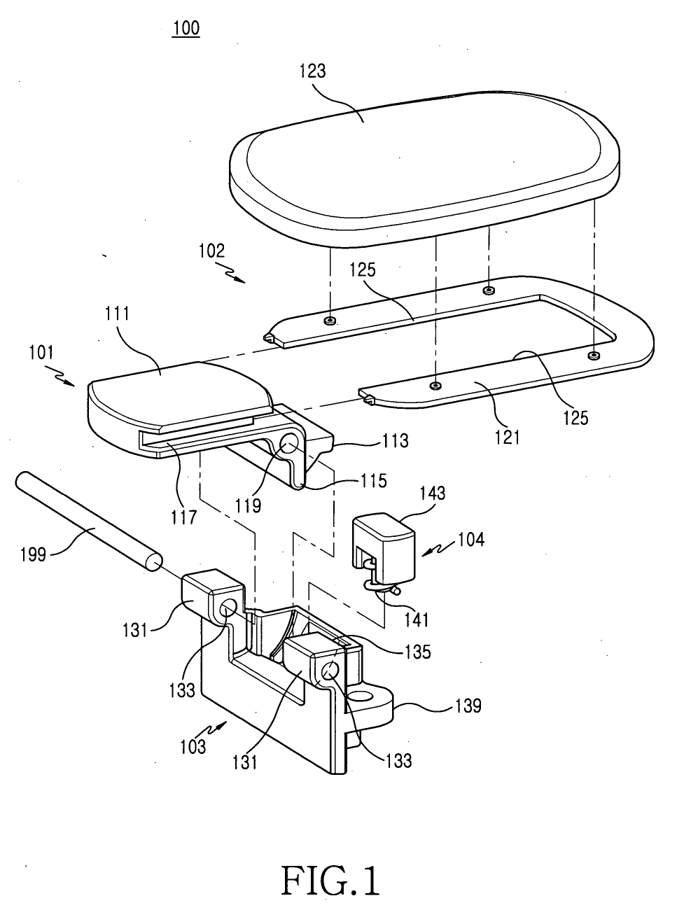

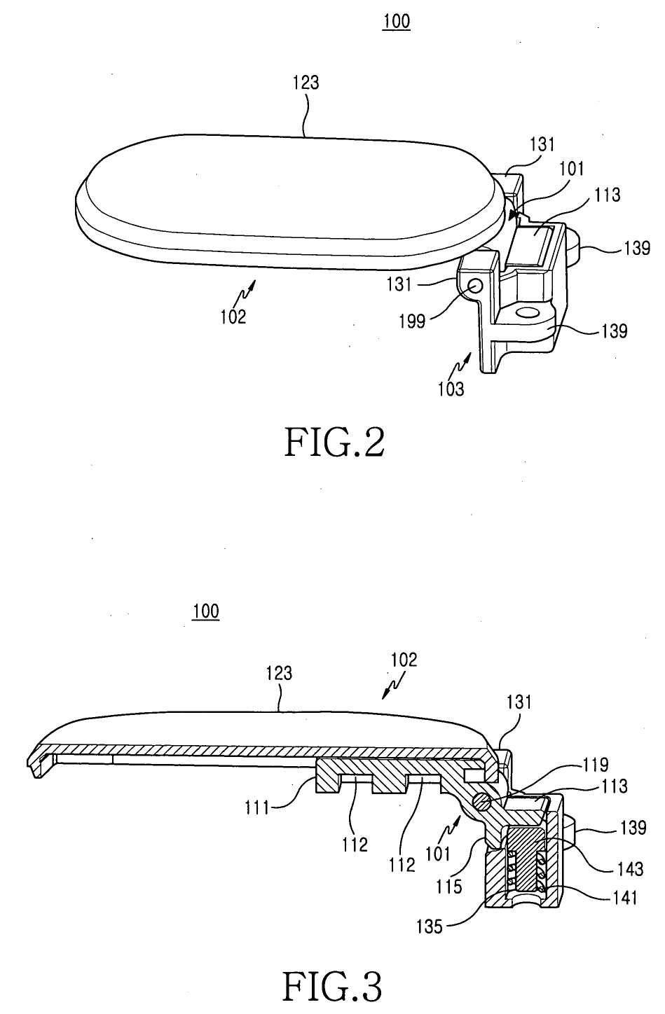

As shown in FIGS. 1 to 4, a battery pack locking device 100 of a portable terminal according to a preferred embodiment of the present invention includes a locking member 101, a cover 102, a mounting member 103, and a driving means 104.

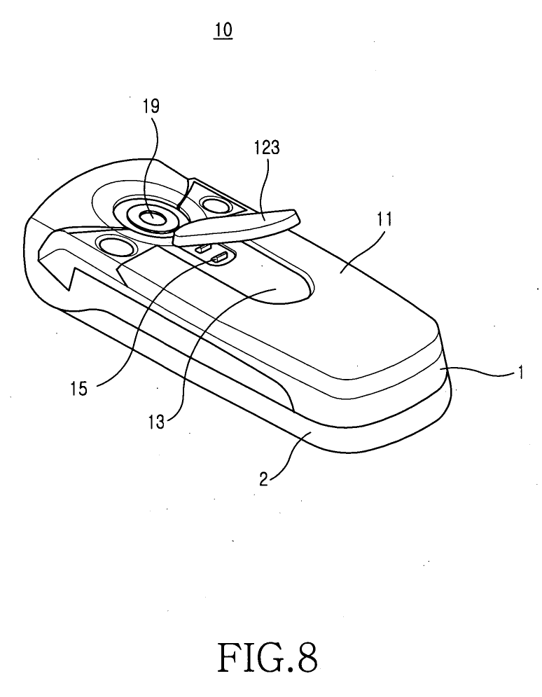

The locking member 101 is pivotally mounted to the portable terminal 10 (as shown in FIG. 8) by using the mounting member 103. The locking member 101 extends along one plane. The locking member 101 includes a locking plate 111 positioned on a battery pack mounting surface of the portable terminal. The locking plate 111 is biased by a predetermined resilient force and is pivoted toward the battery pack mounting surface. To receive the resilient force pivoting the locking plate 111, the locking member 101 includes a driving plate 113 extending in a direction different from the extending direction of the locking plate 111. A pivoting pin 199 is engaged between the locking plate 111 and the driving plate 113 to provide a pivotal axis of the locking member 101. The locking plate 111 and the driving plate 113 extend in a parallel orientation.

Preferably, at least one pair of locking recesses 112 are formed in the locking plate 111. The locking plate 111 presses an outer surface of a battery pack 11 (as shown in FIG. 8) mounted to the portable terminal 10 in a direction that fixes the battery pack to the portable terminal 10.

Referring to FIG. 5, a sliding recess 13 recessed to a predetermined depth and locking bosses 15 protruding on the surface of the sliding recess 13 are formed on an outer surface of the battery pack 11. When the battery pack 15 is mounted to the portable terminal 10, the cover 102 is slidably moved in the sliding recess 13 and the locking bosses 15 are engaged with the locking recesses 112. After the battery pack 11 is adhered to a battery mounting surface of the portable terminal 10, it is slidably moved. At least one pair of engaging ribs are formed on both sides of the battery pack 11. The engaging ribs 17 are engaged with corresponding engaging ribs (not shown) formed in the portable terminal 10 to attach the battery pack 11. If the battery pack 11 is engaged with the portable terminal 10 completely, the locking plate 111 applies a force to the outer surface of the battery pack 11. At the same time, the locking bosses 15 are engaged with the locking recesses 112. The battery pack 11 is kept in a fixed position by fixing the battery pack 11 to the portable terminal.

The locking member 101 includes a driven plate 115 extending between the locking plate 111 and the driving plate 113 in a perpendicular direction. When the locking member 101 pivots, the driven plate 115 is blocked by the battery pack 11 mounted to the portable terminal 10 and slides the battery pack 11.

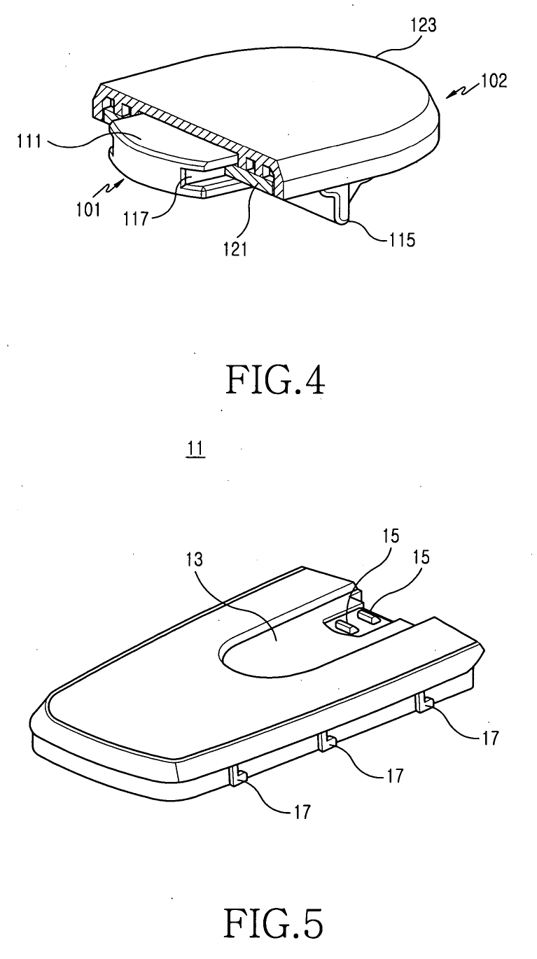

The cover 101 includes a sliding plate 121 slidably mounted to the locking member 101 and a cover plate 123 fixed to the sliding plate 121. The sliding plate 121 has a U-shape. Guide ribs 125 extending in a lengthwise direction thereof are formed on the inner side of the sliding plate 121. Guide recesses 117 are formed on both side surfaces of the locking plate 111, so that, as shown in FIG. 4, the guide ribs 125 and the guide recesses 117 are engaged with each other to allow slidable movement with respect to each other. Therefore, the sliding plate 121 is engaged with the locking plate 111 so as to surround the locking plate 111 and is slidably moved on the locking plate 111 in a lengthwise direction.

The cover plate 123 is fixed to the sliding plate 121, and prevents the locking plate 111 and the sliding plate from being exposed. The cover plate 123 also improves appearance.

Where the battery pack 11 is mounted to the portable terminal, the cover 102 can be slid in the sliding recess 13. As the cover 101 is slid on the portable terminal 10, it is located in the sliding recess 13 or a portion thereof opens and closes the outer surface of the portable terminal 10.

The mounting member 103 is fixed to the portable terminal 10, and a pair of support bosses 131 pivotally supporting both sides of the locking member 101 are formed in the mounting member 103. Namely, the mounting member 103 pivotally mounts the locking member 101 to the portable terminal 10. The mounting member 103 can be integrally formed with the portable terminal 10 or manufactured separately. Engaging pieces 139 for engaging the mounting member 103 to the portable terminal are formed in the mounting member 103.

The support bosses 131 are formed so as to be opposite to each other, and the locking member 101 is located between them. Pivot holes 119 and 133, arranged in axial alignment, i.e. a straight line, are formed in the support bosses 131 and the locking member 101, and a pivot pin 199 extending in a lengthwise direction thereof is engaged with the pivot holes 199 and 133. The locking member 101 is pivoted about a pivotal axis, i.e. the pivot pin 199. The pivot hole 119 formed in the locking member 101 is formed between the locking plate 111 and the driving plate 113. The locking plate 111 is pivoted as a resilient force is applied to the driving plate 113, which is pivoted about the pivot pin 199.

A receiving recess 135 is formed in the mounting member 103, and the driving means 104 is received in the receiving recess 135. The opened end of the receiving recess 135 faces the driving plate 113.

The driving means 113 includes a resilient member 141 and a driving button 143. The resilient member 141 is received in the receiving recess 135. One end of the resilient member 141 is supported by the driving plate 113 through the driving button 143. The resilient member 141 is preferably a compression coil spring, and the resilient force of the resilient member 141 is applied to bias the locking plate 111 toward the battery pack mounting surface of the portable terminal 10.

The resilient member 141 is not blocked by the inner walls of the receiving recess 135 due to the driving button 143. The driving button 143 provides the driving plate with a smooth resilient force. If the resilient member 141 is not blocked by the inner walls of the receiving recess 135, the driving button can be excluded. The driving button 143 is provided with the resilient force of the resilient member 141 at the opened end of the receiving recess 135 and is pressed down into the mounting member 103 and then is released from the depressed position.

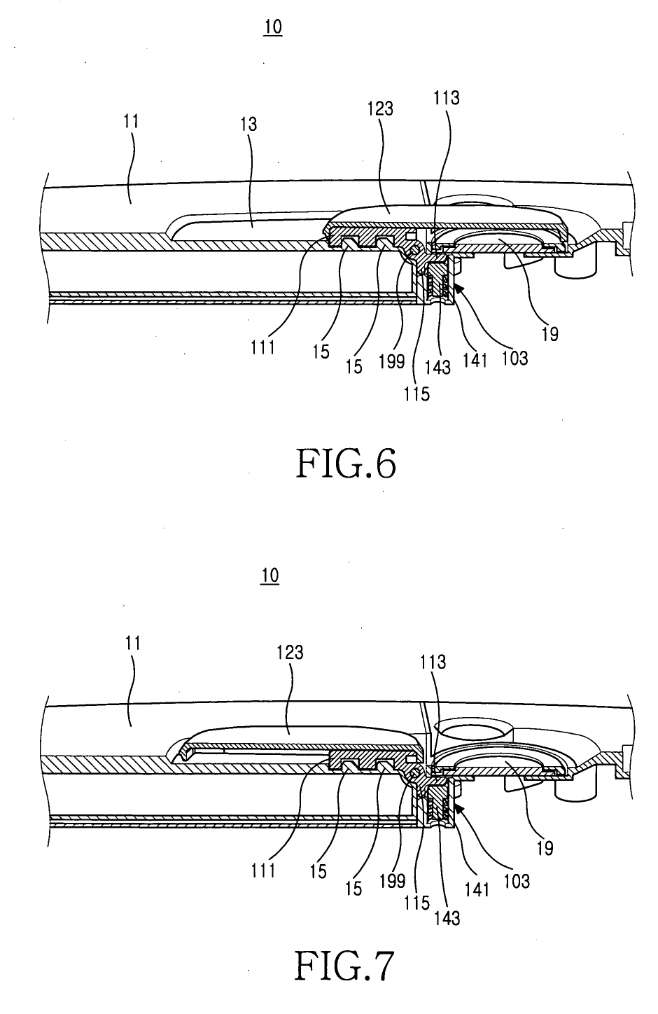

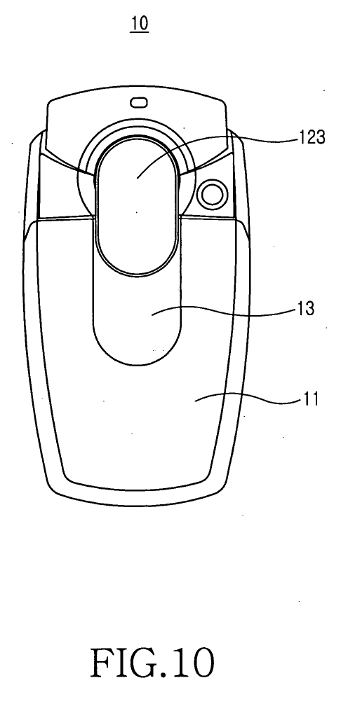

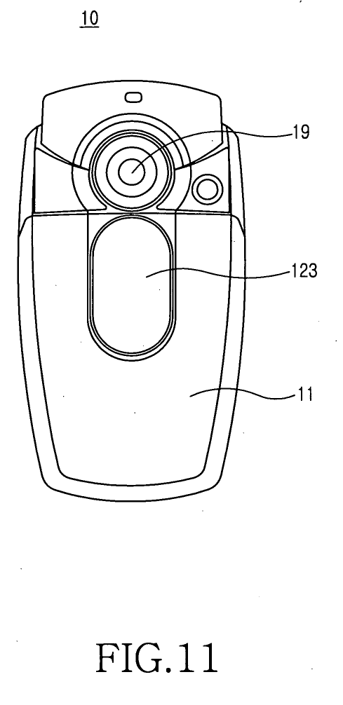

FIGS. 6 and 7 are partially cut-away perspective views showing the battery pack locking device 100 mounted to a portable terminal 10. FIGS. 10 and 11 show that the cover 102 of the locking device 100 opens and closes a portion of an outer surface of the portable terminal 10.

As shown in FIGS. 6 and 7, as the locking plate 111 presses the battery pack 11 with the resilient force of the resilient member 141, the battery pack 11 mounted to the portable terminal 10 is attached to the portable terminal 10 and the locking bosses 15 are engaged with the locking recess 112 to restrict the sliding movement of the battery pack 10. Further, the engaging ribs 17 formed on both side surfaces of the battery pack 10 are engaged with the engaging ribs (not shown) in the portable terminal to restrict the battery pack 11 from being unintentionally removed from the portable terminal 10.

To separate the battery pack 11 from the portable terminal, the engaging ribs 17 are released. Further, to release the engaging ribs 17, the battery pack 11 should be slidably moved on the portable terminal 10, but the locking bosses 15 and the locking recess 112 are engaged with each other and restrict the sliding movement of the battery pack 11.

The portable terminal 10 includes a camera lens 19 installed adjacent to the surface to which the battery pack 11 is mounted. If the camera lens 19 employs a highly efficient camera device of over one million pixels, it is preferable that the camera lens 19 is closed when the camera lens 19 is not used.

Here, a portion of the outer surface of the portable terminal 10 is closed as the cover 102 is slidably moved on the locking plate 111. The camera lens 19 is installed on the outer surface of the portable terminal 10 opened and closed by the cover 102, and is closed by the cover, as shown in FIG. 6, when the camera lens 19 is not used.

When the cover 102 is closed over the camera lens 19, the pivotal movement of the locking member 101 is restricted. Namely, when the cover 102 is closed over the camera lens 19, the cover 19 is blocked by the outer surface of the portable terminal 10 so that the locking member 101 cannot be pivoted.

As shown in FIG. 7, when the cover 102 is located in the sliding recess 13, the camera lens 19 is opened and a user can take a picture, using the camera lens 19. Further, if the cover 102 is located in the sliding recess 13, the cover 102 is not blocked by the portable terminal 10 and the locking member 101 can be pivoted.

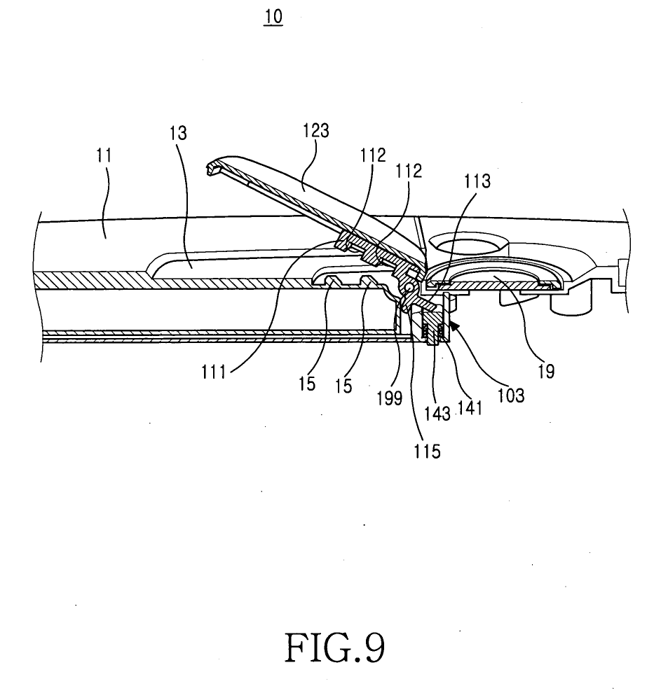

FIGS. 8 and 9 show the battery pack 11 separated from the portable terminal by pivoting the locking member 101.

As shown in FIGS. 8 and 9, to separate the battery pack 11 from the portable terminal, a user pivots the locking member 101 so that the locking plate 111 is withdrawn from the outer surface of the battery pack 11. Referring to FIG. 8, the portable terminal 10 discloses a folder-type portable terminal including a body housing 1 and a sub-housing 2. However, it is apparent that the battery pack locking device according to the present invention can be applied to an arbitrary type of portable terminal that employs a battery pack, such as a sliding type portable terminal, a bar-type portable terminal, a flip-type portable terminal, etc.

If the locking member 101 is pivoted, the locking bosses 15 are separated from the locking recesses 112 and the driven plate 115 is blocked by one end of the battery pack 11 to slide the battery pack 11.

If the battery pack 11 is slid by the driven plate 115, the engaging ribs 17 are released and a user can separate the battery pack 11 from the portable terminal 10.

As the locking member 10 pivots, the driving plate 113 presses the driving button 143 and withdraws the driving button 143 into the receiving recess 135. The resilient member 141 accumulates a predetermined resilient force, which is applied in the direction of the locking plate 111 approaching the portable terminal 10. If the force pivoting the cover 102 or the locking plate 111 is removed, the locking member 101 receives the resilient force of the driving means and is pivoted in the direction in of locking plate 111 approaching the portable terminal.

As described above, since a battery pack locking device of a portable terminal according to the present invention includes a locking member pivotally mounted to the portable terminal and pressing an outer surface of the battery pack with a predetermined resilient force and a cover engaged with the locking member so as to be slidably moved, the battery pack is securely fixed and a camera lens is protected by opening and closing a portion of an outer surface of the portable terminal. More specifically, since the present invention integrates the camera lens cover with the battery pack device in one module, the mounting space of the portable terminal is used more efficiently and thus, the portable terminal can be miniaturized.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A battery pack locking device of a portable terminal, the battery pack locking device comprising:
a locking member pivotally engaged with the portable terminal and provided with a locking plate extending in a direction to press the battery pack into the portable terminal;
a resilient member providing a resilient force on the locking plate against the battery pack; and
a cover engaged with the locking member for slidable movement.

2. A battery pack locking device according to claim 1, wherein the cover opens and closes a camera lens as the cover slidably moves on the portable terminal.

3. A battery pack locking device according to claim 1, wherein the cover comprises a sliding plate engaged with the locking plate for slidable movement; and a cover plate fixed to the sliding plate.

4. A battery pack locking device according to claim 3, further comprising:
guide recesses formed on side surfaces of the locking plate; and
guide ribs formed on the sliding plate so as to face the guide recesses and engage with the guide recesses for slidable movement.

5. A battery pack locking device according to claim 1, further comprising:
a mounting member fixed to the portable terminal, with which the locking member is pivotally engaged, the mounting member comprising a pair of support bosses surrounding side ends of the locking member.

6. A battery pack locking device according to claim 5, wherein the locking member is located between the support bosses and further comprises a pivot pin engaged with the support bosses and the locking member so as to penetrate the support bosses and the locking member.

7. A battery pack locking device according to claim 5, further comprising:
a receiving recess formed in the mounting member to receive the resilient member.

8. A battery pack locking device according to claim 1, further comprising:
a driving plate extending from the locking member and supporting an end of the resilient member.

9. A battery pack locking device according to claim 8, further comprising:
a driving button interposed between the end of the resilient means and the driving plate.

10. A battery pack locking device according to claim 5, wherein a driving button is received in the mounting member together with the resilient member to be pressed down into, and released from, the mounting member.

11. A battery pack locking device according to claim 1, further comprising:
at least one locking boss formed on an outer surface of the battery pack; and
locking recesses formed on one surface of the locking plate and engaged with the locking boss.

12. A battery pack locking device according to claim 1, further comprising:
a driven plate extending from the locking member, the driven plate slidably moving the battery pack on the portable terminal as the locking member is pivoted.

13. A battery pack locking device according to claim 1, wherein as the cover is slidably moved on the portable terminal, a portion of the cover is located on an outer surface of the portable terminal and the entire cover is located on the battery pack.

14. A battery pack locking device according to claim 13, wherein the pivotal movement of the locking member is restricted when a portion of the cover is located on the outer surface of the portable terminal.
